(19) United States
(12) Patent Application Publication
(10) Pub. No.: US 2011/0027330 A1
(43) Pub. Date: Feb. 3, 2011

(54) Tablet composition for the in-situ generation of chlorine dioxide for use in antimicrobial applications

(76) Inventor: Roy W. Martin, Downers Grove, IL (US)

Correspondence Address: Roy W. Martin, 1440 Palmer, Downers Grove, IL, 60516, US

(21) Appl. No.: 12/924,293

(22) Filed: Sep. 24, 2010

Related U.S. Application Data
(63) Continuation-in-part of application No. 12/806,964, filed on Aug. 25, 2010.
Application No. 12/806,964 is a continuation-in-part of application No. 12/802,230, filed on Jun. 2, 2010.
Application No. 12/802,230 is a continuation-in-part of application No. 12/660,470, filed on Feb. 25, 2010.
Application No. 12/660,470 is a continuation-in-part of application No. 12/655,953, filed on Jan. 11, 2010.
Application No. 12/655,953 is a continuation-in-part of application No. 12/653,984, filed on Dec. 22, 2009.
Application No. 12/653,984 is a continuation-in-part of application No. 12/380,329, filed on Feb. 26, 2009.
Application No. 12/380,329 is a continuation-in-part of application No. 11/253,977, filed on Oct. 18, 2005, now Pat. No. 7,534,368.
Application No. 11/253,977 is a continuation-in-part of application No. 11/154,086, filed on Jun. 15, 2005, now Pat. No. 7,514,019.
Application No. 11/154,086 is a continuation-in-part of application No. 11/070,132, filed on Mar. 1, 2005, now abandoned.

(51) Int. Cl. A01N 25/34; A01N 59/08; A01P 1/00

(52) U.S. Cl. 424/408; 424/665

(57) ABSTRACT

A fast-acting solid composition in the form of a tablet that generates and releases a biocidal solution comprising at least chlorine dioxide with an enhanced weight percent yield of at least 20 wt % is presented. The composition comprises reactants capable of in-situ generation of chlorine dioxide comprising a chlorite donor that is coated with a non-hygroscopic material that enhances the environmental stability of the composition.

### RELATED APPLICATIONS

This application is a Continuation-in-Part (CIP) of U.S. patent application Ser. No. 12/806,964 filed on 25 Aug. 2010, which is a CIP of U.S. patent application Ser. No. 12/802,230 filed on 2 Jun. 2010, which is a CIP of U.S. patent application Ser. No. 12/660,470 filed on 25 Feb. 2010, which is a CIP of U.S. patent application Ser. No. 12/655,953 filed on 11 Jan. 2010, which is a CIP of U.S. patent application Ser. No. 12/653,984 filed on 21 Dec. 2009, which is a CIP of U.S. patent application Ser. No. 12/380,329 filed on 26 Feb. 2009, which is a CIP of U.S. patent application Ser. No. 11/253,977 filed on 18 Oct. 2005, which is now U.S. Pat. No. 7,534,368, which is a CIP of U.S. patent application Ser. No. 11/154,086 filed on 15 June, 2005 which is now U.S. Pat. No. 7,514,019, which is a CIP of U.S. patent application Ser. No. 11/070,132 filed on 1 Mar. 2005 which is now Abandoned. The entire contents of these patent applications are incorporated by reference herein.

### FIELD OF INVENTION

This invention relates to a solid composition in the form of a tablet that produces chlorine dioxide when contacted with an aqueous solution that is sufficiently stable for bulk packaging, provides a controlled release of at least chlorine dioxide, and is suitable for use in a multi-tablet chemical dispenser. The tablet of the invention provides at least a 20 weight percent yield of chlorine dioxide and enhanced environmental stability. The weight percent yield (wt % yield) achieved by a solid composition in the form of a tablet of the invention is unprecedented.

### BACKGROUND

Oxidizing biocides are commonly used for the treatment of recirculating systems such as industrial cooling systems. It is common for tablet forms to be applied thru feeders such as flow through chlorinators or brominators. However, in many instances chlorine and bromine alone are not sufficient for the control of microbiological activity, especially in contaminated systems and/or where the pH is elevated which reduces the effectiveness of chlorine and bromine oxidizers.

Chlorine dioxide is an effective antimicrobial agent for use in food processing applications. Examples of food process applications include but are not limited to: vegetable and fruit washing, cleaning of animal processing equipment, cleaning of animal carcasses, treatment of poultry and animal habitats.

Chlorine dioxide has been shown to be very effective for the control of microbiological organisms. However, cost effective generation of chlorine dioxide requires on-sight generation from liquid reagents and substantial capital investment.

In recent years, tablets that generate chlorine dioxide have been developed, however their use in the treatment of recirculating systems is very limited due to high use cost and limited utility. High use cost is attributed to the tablet's low yields of chlorine dioxide and poor environmental stability that requires costly individual packaging of the tablets. Also, the high reactivity and rapid release of the chlorine dioxide results in a spike of treatment rather than the desirable controlled release to achieve a sustained concentration of treatment, and subsequent potential for generation of explosive conditions when applied in multi-tablet chemical dispensers due to elevated levels of potentially hazardous and explosive gas.

U.S. Pat. No. 6,699,404 to Speronello (“the Speronello patent”) discloses a massive body having a porous structure which substantially increases the percent conversion of chlorite to chlorine dioxide when compared to chlorite powder. The Speronello patent discloses two types of massive bodies: a water soluble type and a substantially water insoluble type. The substantially water insoluble massive body forms a porous framework that provides a higher efficiency of the conversion compared to the water-soluble massive body. According to the test data provided in the Speronello patent the maximum concentration of chlorine dioxide produced by a massive body that forms the porous framework is 149.4 mg/L. The water-soluble massive body reported (example 4) a maximum 27.4 mg/L.

In order to achieve 70% or more conversion of the chlorite to chlorine dioxide using the method disclosed in the Speronello patent, a substantial amount of inert materials are added to produce the porous structure or the porous framework. The level of inert salts ranges from 18 wt. % to 80 wt. %, with higher weight percentages increasing the conversion efficiency. The high levels of inert material, particularly in the water-soluble massive body, are further illustrated in commercial practice. For example, Aseptrol®, which is the commercialized product embodying the invention disclosed in the Speronello patent, is a water soluble tablet that requires 1.5 grams of Aseptrol® to 1 liter of water to produce 100 mg/L chlorine dioxide. This equates to approximately 67 mg/L chlorine dioxide based on 1 gram tablet per liter. The weight-% yield, which is defined as weight of the chlorine dioxide divided by the weight of the tablet, is low because of the high level of inert material. According to the data reported in the Speronello patent, the weight % yield is less than 15 wt. %, and less than 3% in the case of the water-soluble massive body. Based on the commercial product Aseptrol®, the weight percent yield of the water soluble commercial product is 6.7 wt. %.

It is desirable to increase the concentration of chlorine dioxide produced by a given mass of tablet to improve the economics based on the cost per pound of the tablet material versus pounds of chlorine dioxide produced. Such increase would also result in an overall performance enhancement offered by higher concentrations of chlorine dioxide. To achieve this objective, tablet conversion efficiency of >70% and a high reactant weight percent are desirable. It is also desirable to substantially increase the concentration of chlorine dioxide using a completely water-soluble composition to eliminate the problems associated with water insoluble constituents or byproducts such as residue silica based clays, or mineral salts such as calcium sulfate.

U.S. Pat. Nos. 6,384,006 and 6,319,888 to Wei et al. (“the Wei patents”) disclose a system for forming and releasing an aqueous peracid solution. The system includes a container and a peracid forming composition that includes about 10-60 wt. % of a chemical heater that, upon contact with water, generates heat to increase the yield of the peracid.

The Wei patents describe the potential use of a viscosity modifier within a permeable container to increase the viscosity in the localized area from about 300 to about 2,000 centipoise. The increased viscosity restricts and slows down the movement of peracid precursor and/or peroxygen source out of the permeable container. This results in an increased residence time of the peracid precursor and peroxygen source within the permeable container, which in turn translates to a greater reaction rate.

U.S. Pat. No. 6,569,353 to Giletto et al. (“the Giletto patent”) discloses using silica gel to increase the viscosity of various oxidants including an in-situ generated oxidant in order to keep them in intimate contact with the agents targeted for oxidation.

U.S. Published Application No. 2001/0012504 to Thangaraj et al. (“the Thangaraj application”) discloses a composition for producing chlorine dioxide comprising an acid source and a chlorite source, and a method comprising enclosing the composition in a gelatin capsule or membrane sheet such as a “tea bag”.

U.S. Pat. No. 5,688,515 discloses a composition comprising trichloroisocyanuric acid, sodium bromide, and dimethylhydantoin to produce hypobromous acid.

Patent Application WO 2007/078838 discloses a composition comprising an oxidizer and bromide donor along with a chlorite donor to produce chlorine dioxide. The compositions disclosed generate chlorine dioxide rapidly and preferably without the use of chlorine donors such as chlorinated isocyanurates. The compositions also require special packaging to prevent chlorine dioxide generation resulting from relative humidity.

In order to improve reaction kinetics, the above references teach using substantial quantities of inert materials to either provide a porous structure as in the case of the Speronello patent, or heat as in the cases of the Wei patents. While viscosity modifiers are referenced in the Wei patents, the viscosity range disclosed in the Wei patents does not reflect the formation of a gel.

U.S. Pat. No. 7,514,019 B2 discloses a solvent-activated reactor including a gel layer that allows for a water-soluble tablet composition that delivers at least a 70 wt % conversion of chlorite to chlorine dioxide and at least 14 wt % yield. However, the maximum yield of chlorine dioxide achieved in the disclosed data was 18.1 weight percent.

U.S. Pat. No. 7,465,410 B2 discloses a solvent-activated reactor comprising a core of reactants that are encapsulated by a solvent-permeable reactor wall. The solvent activated reactor allows for a convenient means of generating a target product, however provides no improvements in weight percent yield or environmental stability than that disclosed in U.S. Pat. No. 7,514,019 B2.

U.S. Pat. No. 7,150,854 discloses a device comprising a substrate and reagents that permits the rapid release of relatively small quantities of chlorine dioxide in liquid water as needed and is therefore quite useful for sterilizing water such that it is potable and useful as a germicidal liquid. Furthermore, the present invention lends itself to the separation of the reaction precursors into discrete zones or domains, thereby resulting in increased shelf life and the avoidance of expensive packaging.

Search still continues for a method of stabilizing reactive components for storage without compromising or limiting their function during usage. Furthermore, it is highly desirable to have an environmentally stable composition in the form of a tablet that provides an weight percent yield of chlorine dioxide that is at least 20 wt %, preferably 25 wt % and most preferably at least 30 wt %.

### SUMMARY

It has been discovered that a solid composition in the form of a tablet having enhanced environmental stability and a weight percent yield of at least 20 wt %, more preferably 25 wt %, and most preferably 30 wt % is obtained by: combining a low solubility free halogen donor; an acid source; a chlorite donor; and wherein the reactants and components comprising the solid composition having a solubility of greater than 5 grams per 100 ml at 25° C. are coated with a non-hygroscopic material; mixing the reactants and components, and applying a force to compact the solid components into a tablet.

The tablets of the disclosed composition, while having enhanced environmental stability, when immersed in water produce at least 20 wt % chlorine dioxide and achieve a conversion of chlorite anion to chlorine dioxide of at least 70 wt % substantially faster than the tablets disclosed in co-pending U.S. patent application Ser. No. 12/802,230.

The benefits resulting from the disclosed invention are the dramatic improvements in environmental stability and the subsequent increased utility. The tablets of the invention can be individually wrapped, packaged in bulk wherein many tablets are combined in one package, and applied in a multi-tablet dispenser. The invention provides for a tablet with enhanced weight percent yield of chlorine dioxide whether used alone or in combination with multiple tablets.

The non-hygroscopic coating inhibits the adsorption of moisture onto at least the surface of the hygroscopic chlorite donor. The non-hygroscopic material coating, combined with the use of low solubility free halogen donor, provides for a synergistic chemistry that restricts the premature formation of chlorine dioxide due to humidity, provides for a solid composition that provides at least 20 wt % yield of chlorine dioxide, allows for bulk packaging, and use in a multi-tablet chemical dispenser.

Without holding to a specific theory, it is believed combining: at least one low solubility free halogen donor; a chlorite donor coated with a non-hygroscopic coating; an acid source which may also be coated with a non-hygroscopic material, and/or using a non-hygroscopic acid source exemplified by fumaric acid, restricts the adsorption of environmental moisture and further impedes intimate contact between the reactants and components thereby restricting premature generation and release of chlorine dioxide. The selection and use of non-hygroscopic materials having the properties disclosed allows for high levels of reactants that may otherwise result in an incompatible and/or unstable solid composition. Furthermore, when the solid composition in the form of a tablet is immersed in water, the use of at least one low solubility free halogen donor with reactants that are coated with at least one non-hygroscopic material restricts the rapid dissolution of the reactants within the tablet until such time that they have substantially reacted to form chlorine dioxide, resulting in a chlorite conversion to chlorine dioxide of at least 70 wt %, more preferred at least 80 wt %, and most preferred at least 90 wt %. The invention allows the use of extremely high levels of reactants and high wt % yield of chlorine dioxide in a fast-acting solid composition in the form of a tablet.

A solid composition in the form of a tablet comprising a low solubility free halogen donor and low solubility acid source exemplified by trichloroisocyanuric acid and fumaric acid respectfully, and a chlorite donor coated with a non-hygroscopic material exemplified by sodium chlorite coated with fumed silica, sufficiently restricts the dissolution rate of the reactants when immersed in water so that the tablet can generate at least 20 wt % yield, more preferably 25 wt %, and most preferably 30 wt % yield of chlorine dioxide. Furthermore, the tablet can be produced and stored while substantially reducing the potential for premature off-gassing of chlorine dioxide.

The use of low solubility reactants and/or coating higher solubility reactants with non-hygroscopic materials allows for a solid composition in the form of a tablet with high levels of reactants and low levels of inert materials, which result in a tablet that provides a high weight percent yield of chlorine dioxide.

Furthermore, the invention provides for a tablet that is completely water soluble, leaving no insoluble residue behind while providing at least 20 wt % yield, preferably at least 25 wt %, and most preferably at least 30 wt % yield of chlorine dioxide.

Further still, that invention provides for a tablet that is substantially water soluble, leaving no greater than 5 wt % of the original tablet weight of insoluble residue behind while providing at least 20 wt % yield, preferably at least 25 wt %, and most preferably at least 30 wt % yield of chlorine dioxide.

Further still, the invention provides for a tablet that provides at least 20 wt % yield of chlorine dioxide while meeting 5.1 Division Solid Oxidizers, Packing Group II as defined under UN/DOT criteria.

In another aspect, the invention is a fast-acting solid composition in the form of a tablet having enhanced environmental stability. The tablet immersed in water produces at least 20 wt % chlorine dioxide and achieves a conversion of chlorite anion to chlorine dioxide of at least 70 wt % in no greater than 60 minutes when a 1.5 gram tablet in immersed in 1000 ml of water at 20° C.

In another aspect, the invention is a solid composition in the form of a tablet that generates chlorine dioxide and releases an antimicrobial solution for the treatment of food processing applications include but are not limited to: vegetable and fruit washing, cleaning of animal processing equipment, cleaning of animal carcasses, treatment of poultry and animal habitats.

In another aspect, the invention is a solid composition in the form of a tablet that generates chlorine dioxide and releases an antimicrobial solution for the treatment of: recirculating systems including industrial cooling systems, swimming pools, spas, fountains, water parks; and hard surfaces such as those located in buildings and institutions such as hospitals, schools, office buildings, military bases and the like. The invention is also suitable for sanitizing surgical instruments and equipment exemplified by scalpels and endoscopes.

In another aspect, the invention is a solid composition in the form of a tablet that generates chlorine dioxide and releases an antimicrobial solution for the treatment of emergency drinking water. Emergency drinking water may be used by hikers, campers, survivalist, military, and emergency services such as FEMA.

### BRIEF DESCRIPTION OF THE DRAWINGS

FIG. 1 is an exemplary embodiment of the chlorite donor coated with a non-hygroscopic material.

FIG. 2 shows the chlorite donor coated with the non-hygroscopic material of FIG. 1 combined with other reactants after the solvent interface has been exposed to the main solvent.

FIG. 3 shows the chlorite donor coated with the non-hygroscopic material of FIG. 1 combined with other reactants and a binder.

FIG. 4 shows the chlorite donor coated with the non-hygroscopic material of FIG. 1 combined with other reactants and a binder and additional non-hygroscopic material.

FIG. 5 shows the chlorite donor coated with the non-hygroscopic material of FIG. 1 combined with other reactants and additional non-hygroscopic material.

FIG. 6 shows an aggregate composition containing one or more reactants, a chlorite donor coated or encapsulated with a non-hygroscopic material, a non-hygroscopic material that acts as a barrier between reactants, and a desiccant material.

FIG. 7 exemplifies bulk packaging comprising a package such as a pail containing a plurality of tablets comprising the composition.

### DETAILED DESCRIPTION OF THE EMBODIMENT(S)

The invention is particularly applicable to generation and release of chlorine dioxide having bleaching, biocidal, or virucidal properties and it is in this context that the invention will be described. It will be appreciated, however, that the reactor, the method of making the reactor, and the method of using the reactor in accordance with the invention has greater utility and may be used for any other target product(s). Although the main solvent is described as water for clarity of illustration, the invention is not so limited.

As used herein, “fast-acting” is defined a solid composition in the form of a tablet that generates chlorine dioxide, when immersed in water the tablet produces at least 20 wt % yield of chlorine dioxide and achieves a chlorite conversion to chlorine dioxide of at least 70 wt % in no greater than 1 hour when a 1.5 gram tablet in immersed in 1000 ml of water at 20° C.

As used herein, the phrase “chlorite conversion to chlorine dioxide” describes the amount of chlorite anion having the general formula ClO₂⁻ into the in-situ generated product chlorine dioxide having the general formula ClO₂. The amount of conversion is reported as weight percent (wt %) and is determined by dividing the amount (weight) of chlorine dioxide produced by the total amount of chlorite anion (weight) provided by the composition. The equation is represented by ClO₂(mg)/ClO₂⁻(mg)×100=weight %.

As used herein “weight percent yield” defines the amount of chlorine dioxide produced compared to the total weight of the tablet. The weight percent yield (wt %) is determined by dividing the weight of chlorine dioxide produced by the total weight of the tablet. The equation is represented by [ClO₂(mg)/tablet (mg)]×100=wt % yield.

As used herein “food processing applications” include those aspects within the process that utilize antimicrobial treatments to reduce the potential of spread of infectious disease. Applications include: vegetable and fruit washing; cleaning and sanitizing of food processing equipment; cleaning and sanitizing of animal carcasses, poultry, meat, rabbit, and egg products, treatment of poultry and animal habitats.

As used herein, “carboxylic acid donor” describes dicarboxylic acid and tricarboxylic acid that have a molecular weight between 90 and 300 grams per mole. Examples include succinic acid, malonic acid, maleic acid, malic acid, tartaric acid, fumaric acid, glutaric acid, and citric acid. Of these, fumaric acid exemplifies a preferred polycarboxylic acid due to its non-hygroscopic properties.

As used herein, “acid source” describes compounds that contribute hydrogen ions (H⁺) when dissolved in water. Examples of inorganic acid sources include but are not limited to sodium bisulfate, potassium bisulfate, sodium pyrosulfate, and potassium pyrosulfate. Organic based acid sources include but are not limited to fumaric acid, succinic acid, malic acid, tartaric acid, maleic acid, and citric acid.

As used herein, “non-hygroscopic” describes the tablet composition comprising the low solubility free halogen donor, acid source and chlorite donor that resist adsorption or absorption of moisture when exposed to atmospheric humidity thereby substantially reducing the potential for the generation of chlorine dioxide. The non-hygroscopic property of the tablet composition can be achieved by coating at least the hygroscopic components of the tablet composition with a non-hygroscopic material exemplified by: magnesium carbonate light exemplified by Elastocarb® manufactured by Akrochem Corp; untreated fumed silica exemplified by CAB-O-SIL M5, treated fumed silica exemplified by CAB-O-SIL TS530, and fumed alumina exemplified by SpectrA1® manufactured by Cabot Corp.

As used herein, “non-hygroscopic material” describes a material that coats or encapsulates the reactants and components comprising the solid composition thereby restricting the adsorption of environmental moisture, and forming a barrier between the reactants and components. The non-hygroscopic material may also absorb moisture thereby functioning as a desiccant as exemplified by magnesium oxide which is converted to virtually insoluble magnesium hydroxide. The properties of the non-hygroscopic material include: low solubility; low bulk density; and small particle size relative to the reactants and components being coated. The solubility of the non-hygroscopic material in 100 ml of 25° C. water shall be no more than 5 grams in 15 minutes at pH 7.0. The bulk density is preferably no more than 40 lbs per cubic foot, and more preferably no more than 20 lbs per cubic foot, and most preferred no more than 10 lbs per cubic foot. The mean average particle size of the non-hygroscopic material is preferably less than 20% of the mean average particle size of the reactants and components the non-hygroscopic material coats, more preferably less than 10% of the mean average particle size of the reactants and components the non-hygroscopic material coats.

Without intent to limit the non-hygroscopic material suitable for the invention, non-hygroscopic materials include: magnesium carbonate light exemplified by Elastocarb® manufactured by Akrochem Corp; magnesium oxide exemplified by Magnesia 23 manufactured by Magnesia GmbH; untreated fumed silica exemplified by CAB-O-SIL M5, treated fumed silica exemplified by CAB-O-SIL TS530, fumed alumina exemplified by SpectrA1® manufactured by Cabot Corp. Fumaric acid can be used as both an acid source and non-hygroscopic material. Fumaric acid is non-hygroscopic, 90% passes thru a 75 micron sieve, has a low bulk density, has low solubility, and can function as both the non-hygroscopic material and acid source. Other materials that meet the criteria for a non-hygroscopic material may be applicable as well.

As used herein, “environmental moisture” refers to the moisture associated with the relative humidity of the surrounding air and low level moisture associated with the reactants and components comprising the solid composition during and after formation into a tablet.

As used herein, “effective amount of combustion suppressing boron donor” defines an effective amount of boron containing compound exemplified by borax and boric acid that can reduce the combustion rate of the solid composition to a packing group having lower transportation and/or storage restrictions. Division 5.1 Oxidizer Testing in accordance with the Code of Federal Regulations, Title 49, and the United Nations Transportation of Dangerous Goods-Manual of Test and Criteria, Fourth revised edition (2003). Solid Division 5.1 materials are assigned packing groups using the following UN/DOT criteria [49 CFR .sctn.173.127(b)]: (i) Packing Group I is the sub-classification of any material which, in the 4:1 or 1:1 sample to cellulose ratio (by mass) tested exhibits a mean burning time less than the mean burning time of a 3:2 mixture, by mass, of potassium bromate and cellulose. (ii) Packing Group II is the sub-classification of any material which, in the 4:1 or 1:1 sample to cellulose ratio (by mass) tested exhibits a mean burning time less than the mean burning time of a 2:3 mixture, by mass, of potassium bromate and cellulose, and the criteria for Packing Group I are not met. (iii) Packing Group III is the sub-classification of any material which, in the 4:1 or 1:1 sample to cellulose ratio (by mass) tested exhibits a mean burning time less than the mean burning time of a 3:7 mixture, by mass, of potassium bromate and cellulose, and the criteria for Packing Groups I and II are not met.

The addition of an “effective amount of combustion suppressing boron donor” to the solid composition reduces the combustion rate of the solid composition resulting in a reducing the transportation and storage restrictions.

As used herein, the term “controlled release” refers to the solid composition in the form of a tablet, having been contacted with water, produces and releases chlorine dioxide over an extended period of time as opposed to a rapid release, and where the extended period of time can be measured in seconds, minutes, hours or days depending on the size of the tablet. A tablet with equivalent amounts of reactants under identical test conditions without the gel-forming polymer will dissipate in the water in less time than the tablet that includes the gel-forming material.

As used herein, the term “tablet” refers to any geometric shape or size that comprises the components necessary to produce a solution consisting of at least chlorine dioxide, and wherein the components are gathered together to form a single mass. A force is applied to the components resulting in a solid composition in the form of a tablet.

As used herein, the term “slow dissolving” refers to the tablet of the invention having a restricted rate of dissolution compared to the rate of dissolution achieved from a tablet of similar composition that does not comprise a gelling agent. The gelling agent restricts the dissolution of the reactants thereby slowing the rate at which the tablet dissolves, and allows for a sustained release of in-situ generated products rather than a rapid release obtained by fast dissolving masses and powders.

As used herein, the term “free halogen donor” describes a source of free halogen that when dissolved in an aqueous solution contributes at least one of Cl₂, HOCl, OCl⁻, Br₂, HOBr, OBr⁻ the species of which is dependent on the solution pH and the source of free halogen donor. Example sources of free halogen donors include but are not limited to chlorinated cyanuric acid, chlorinated and brominated cyanuric acid, and brominated and/or chlorinated hydantoin. Examples include but are not limited to: trichloroisocyanurate, dichloroisocyanurate, potassium chlorobromoisocyanurate, dibromodimethylhydantoin, bromochlorodimethylhydantoin, dichlorodimethylhydantoin.

As used herein, the term “free halogen” refers to free chlorine comprising any combination or proportion of chlorine gas, hypochlorous acid and hypochlorite ions and/or free bromine comprising any combination of bromine gas, hypobromous acid and hypobromite ions.

As used herein, the term “low solubility free halogen donor” refers to a free halogen donor having a solubility of no greater than 5 grams per 100 ml of water at 25° C. Examples include but may not be limited to trichloroisocyanuric acid, dichlorohydantoin, dibromodimethylhydantoin, bromochlorodimethylhydantoin, and the like.

As used herein, the term “multi-tablet chemical dispenser” describes any convenient feed system that holds multiple tablets of the invention and contacts at least some portion of the tablets with an aqueous solution to produce a solution consisting of at least chlorine dioxide. Examples include flow-thru brominators such as those sold by Great Lakes Water Treatment, Nalco Chemical, and BetzDearborn Inc. whose disperser is exemplified in U.S. Pat. No. 5,620,671, spray feeders like those sold by Arch Chemical and sold under the trade name Pulsar, floating dispensers, or a perforated dispenser such as a minnow bucket or strainer that is immersed into the aqueous solution.

As used herein, the term “enhanced environmental stability” is defined by the solid composition's ability to substantially resist the generation and release of chlorine dioxide until such time that it is exposed to an aqueous solution. A solid composition with enhanced environmental stability substantially reduces the potential of generation and release of chlorine dioxide when exposed to relative humidity such as that experienced during production, packaging, storage and handling. This characteristic greatly increases the utility of chlorine dioxide by reducing cost and improving handling safety.

As used herein, the term “bulk packaging” defines the ability to package a plurality of tablets into one package without segregating each tablet. Example packaging includes but is not limited to plastic bags and/or plastic pails. Bulk packaging requires the tablet possess sufficient environmental and chemical stability as to substantially eliminate the potential for formation of chlorine dioxide during packaging, storage and transport.

As used herein, the term “coated” and various derivatives “coats” and “coating” refers to the application of the non-hygroscopic material onto the surface of a reactant such as the chlorite donor. Coated also includes encapsulation of the reactant by the non-hygroscopic material by application to the surface of the reactant using a means of spray coating a slurry and drying, exemplified by, but not limited to the Wurster process of spray coating. Another method of encapsulating the chlorite or other reactants using a dry method of application of the non-hygroscopic material is a process called Magnetic Assisted Impact Coating (MAIC), or by simply adding a non-hygroscopic material in the form of a powder to the reactants and/or components and mixing using a mechanical mixer exemplified by a ribbon mixer or tumbler.

As used herein, the term “chlorite donor” is a substance that contributes chlorite anions having the formula ClO₂⁻ when dissolved in an aqueous solution. The chlorite donor will generate chlorine dioxide when reacted with hypochlorous acid and/or hypobromous acid. Example of suitable chlorite donors include but are not limited to is sodium chlorite, magnesium chlorite, calcium chlorite as well as other alkali metals chlorite salts.

As used herein, the term “recirculating systems” describes any open aqueous system that consist of a reservoir of water and a system of piping to transport the water, and wherein the water transported through the piping is eventually returned to the reservoir. Examples of recirculating systems include but are not limited to: cooling systems such as cooling towers and cooling ponds, swimming pools, fountains and feature pools.

As used herein, the term “biocidal solution” describes an aqueous solution consisting of at least chlorine dioxide and results from contacting an aqueous solution with the slow dissolving tablet composition of the invention.

As used herein, the term “self-limiting” tablet composition describes the tablet composition's ability to slow or stop the generation of chlorine dioxide as the concentration of the tablet components and chlorine dioxide in the biocidal solution gets too high. Without being held to a particular theory, it is believed the increasing viscosity elevates the concentration of the reactants to where they reach their saturation level and the tablet slows its dissolution rate.

As used herein, the term “water” includes aqueous solution(s) that comprise water, but is not limited to strictly water having the general formula H₂O, wherein “H” is Hydrogen and “O” is Oxygen. The use of the term “water” is not meant to imply limitations to the use of the disclosed solid composition with respect to the quality of the water in an aqueous solution. An aqueous solution may contain contaminants, minerals, dissolved and suspended solids.

The invention is based on the discovery that a solid composition in the form of a tablet can be produced to provide an enhanced weight percent (wt %) yield of chlorine dioxide. The composition comprises reactants capable of generating the target product comprising at least chlorine dioxide through a chemical reaction, and a non-hygroscopic coating on at least the chlorite donor that allows for high yield, increased conversion of chlorite to chlorine dioxide, and enhanced environmental stability. The chemical reaction is triggered when the reactants comprising the solid composition is contacted by an aqueous solution. The reactants include a low solubility free halogen donor, a chlorite donor, an acid source, and a non-hygroscopic material that coats at least the chlorite donor, and preferably any hygroscopic reactants or higher solubility reactants having a solubility in water of greater than 5 grams per 100 ml at 25° C. The chlorite donor is coated or encapsulated within at least some portion of a non-hygroscopic material.

The use of selective reactants and non-hygroscopic coatings restrict the rapid dissolution of the reactants, providing more time in intimate contact for them to react. Furthermore, the low solubility free halogen donor combined with non-hygroscopic coating of hygroscopic reactants and higher solubility reactants significantly enhances the environmental stability of the solid composition in the form of a tablet.

Of significant benefit is that the tablet comprises sufficient amounts of reactants to achieve at least 20 wt % chlorine dioxide. Because of the synergistic effect of combining: a low solubility free halogen donor; a chlorite donor coated with a non-hygroscopic material; and an acid source, high levels of reactants can be included in order to achieve the high weight percent yield of chlorine dioxide. Large amounts of inert additives needed to form channels etc. like that disclosed in disclosed prior art are averted and higher concentrations of reactants and subsequent higher weight percent yields of chlorine dioxide are achieved.

Thus far, the oxidizing power of chlorine dioxide has not been fully exploited because the cost of equipment to produce chlorine dioxide in-situ to the application is prohibitively high. Also, when using conventional powders or tablets, the economics are severely compromised due to poor “weight % yield” of the powders and tablets as well as the cost of producing these chlorine dioxide generators. The poor “weight % yield” is demonstrated in the '404 Patent discussed above. Furthermore, the utility of chlorine dioxide tablets is compromised due to the poor environmental stability which results in individually wrapped tablets.

The ability to produce a tablet composition that: generates a high weight % yield of chlorine dioxide; has enhanced environmental stability so that it can be packaged in bulk wherein multiple tablets can be combined into one package rather than individually wrapped; have a controlled release rate when immersed in water to provide chlorine dioxide over an extended period of time; and be self-limiting so that the dissolution rate of the tablet composition substantially slows or stops as the concentration of the tablet composition components in the biocidal solution is substantially elevated, provides a tablet composition that eliminates the existing barriers for use of chlorine dioxide in multi-tablet dispensers.

Chlorine Dioxide

In one embodiment, a solid composition with enhanced environmental stability comprises: a solid chlorite donor in an amount to obtain at least 20 wt % chlorine dioxide when the composition is contacted with water; a low solubility free halogen donor exemplified by trichloroisocyanurate (TCCA) and ranging from 12-60 wt %, and in sufficient amount to convert at least 70 wt % of the chlorite anion to chlorine dioxide; an acid source in sufficient amount to provide a pH of less than 7.8 when 1 gram of tablet composition is dissolved in 100 ml of water; at least one non-hygroscopic material comprising from 0.1 wt % to 10 wt % of the composition and wherein at least some portion of the non-hygroscopic material coats at least the chlorite donor.

The chlorite donor is exemplified by sodium chlorite having from about 33-69 wt % as commercial sodium chlorite based on having an 82 wt % sodium chlorite activity (approximately 20.0-42.0 wt % as chlorite anion) and providing at least 20 wt % chlorine dioxide when immersed in water. The acid source may comprise from 3-50 wt % of the composition depending on the acidity of the acid source and chemistry of the final solid composition.

The properties of the non-hygroscopic material are preferably: low solubility; low bulk density; and smaller particle size compared to the reactants and components being coated. The solubility of the non-hygroscopic material in 100 ml of 20° C. water preferably is no more than 5 grams in 15 minutes at pH 7.0. The bulk density is preferably no more than 40 lbs per cubic foot, and more preferably no more than 20 lbs per cubic foot, and most preferably no more than 10 lbs per cubic foot. The mean average particle size of the non-hygroscopic material is preferably less than 20% of the mean average particle size of the reactants and components the non-hygroscopic material coats, more preferably less than 10% of the mean average particle size of the reactants and components the non-hygroscopic material coats.

Without intent to limit the sources and types of non-hygroscopic material, examples include: magnesium carbonate light exemplified by Elastocarb® manufactured by Akrochem Corp; magnesium oxide exemplified by Magnesia 23 manufactured by Magnesia GmbH; untreated fumed silica exemplified by CAB-O-SIL M-5, treated fumed silica exemplified by CAB-O-SIL TS-530, and fumed alumina exemplified by SpectrA1® manufactured by Cabot Corp. Fumaric acid has shown itself to functions as an effective non-hygroscopic material as well as an acid source. Fumaric acid having a solubility of less than 1 wt % at 25° C., and a particle size of approximately 75 μm, and is resistant to caking from adsorption of moisture.

A desirable property of the non-hygroscopic material is having a low bulk density, preferably less than but not limited to 40 lbs per cubic foot, and more preferably 20 lbs per cubic foot, and most preferred 10 lbs per cubic foot. Another desirable property is having an average particle size of less than 200 micron, more preferably less than 100 micron, and most preferably less than 10 micron. Reduced particle size and bulk density enhances coating distribution.

Magnesium carbonate light and similar non-hygroscopic materials can be used in applications where the solid composition in the form of a tablet is completely soluble, whereas fumed silica as an example is used where some insoluble particulate is acceptable.

The preferred chlorite donor is sodium chlorite. However other chlorite donors that provide chlorite anions (ClO₂⁻) when dissolved in water could be used in the composition.

Low solubility free halogen donors contribute halogen based oxidizers when contacted with an aqueous solution. For example, Trichloroisocyanuric acid (TCCA) releases free chlorine as it is dissolved by water. The species of the free chlorine is dependent on the pH of the solution. The species of free chlorine can include Cl₂, HOCl, and OCl⁻. The species of free bromine can include Br₂, HOBr, and OBr⁻. Low solubility free halogen donors suitable for the solid composition in the form of a tablet shall contribute at least 60 wt % free halogen reported as Cl₂, and have a solubility of less than 5 gm/100 ml at 25° C.

An acid donor consumes the hydroxide alkalinity released from the formation of chlorine dioxide and released from the chlorite donor. The pH of the resulting biocidal solution was illustrated in the example test of the referenced co-pending applications. Acid sources can be organic and inorganic. Examples of organic acid sources include but are not limited to cyanuric acid, succinic acid, fumaric acid, tartaric acid, and citric acid. The preferred acid source is a dicarboxylic or tricarboxylic acid exemplified by fumaric acid and citric acid respectively. Fumaric acid is an example of a preferred organic acid having limited solubility and being substantially non-hygroscopic. Examples of inorganic acid sources include but are not limited to sodium bisulfate, potassium bisulfate, sodium pyrosulfate and the like.

In another embodiment, a fast-acting solid composition in the form of a tablet that produces a solution of chlorine dioxide on demand upon contact with water comprises: sodium chlorite ranging from about 33-69 wt % as commercial sodium chlorite based on having an 82 wt % sodium chlorite activity and in an amount to obtain at least 20 wt % chlorine dioxide when the composition is contacted with water; trichloroisocyanuric acid ranging from 12-64 wt % and in sufficient amount to convert at least 70 wt % of the chlorite anion to chlorine dioxide; fumaric acid ranging from about 3-50 wt % and in sufficient amount to provide a pH of less than 7.8 when 1 gram of tablet composition is dissolved in 100 ml of water, the fumaric acid functioning as an acid source and non-hygroscopic material, provides a protective barrier on the surfaces of the chlorite donor, inhibits the adsorption of environmental moisture onto the surface of the chlorite donor, and restricts the premature formation of chlorine dioxide, and

wherein all wt % being based on the total weight of the composition unless otherwise stated.

### Optional Components in the Reactor

### 1) Flame Retardants or Flame Suppressants

Flame retardants, also referred to as flame suppressants can be used to reduce the Department of Transportation classification. Without intent to limit the sources and types of flame retardant material, examples include: borates and boric acid and the like exemplified by Polybor® and Optibor® both manufactured by U.S. Borax.

### 2) Surfactants

In some instances surfactants can be incorporated into the composition to reduce the dissolution rates of the higher solubility reactants as well as provide a synergistic effect in combination with the biocidal solution. For example, a block copolymer surfactant exemplified by Pluronic® manufactured by BASF can reduce the dissolution rate of the reactants as well as provide surfactant to the biocidal solution to enhance the performance of the chlorine dioxide by increasing the penetration of biofilms and membranes of microbiological organisms. Other examples include poly (ethylene oxide) sold by Dow Chemical under the name Polyox.

### 3) Lubricants and Binders

Other additives such as lubricants and binders can be added to enhance the manufacturing of the tablet as well as reduce the dissolution rate of the tablet. Magnesium Stearate, Luwax® exemplified by Luwax® AF 30 and manufactured by BASF, sodium stearyl fumarate and the like.

### 4) Anti-Caking Agents

It may be advantageous to apply an anti-caking agent exemplified by magnesium carbonate light, untreated fumed silica and treated fumed silica. Fumed silica is sold under the trade name CAB-O-SIL® and is manufactured by Cabot Corporation. Anti-caking agents can also reduce the hygroscopic nature of sodium chlorite as well as the entire solid composition. Other anti-caking agents may include but are not limited to: calcium silicate, silicon dioxide, kaolin, talc, bentonite, sodium aluminosilicate and the like.

### 5) Gelling Agent

Gelling agents are combined with the reactants to form a mixture. Gelling agents, upon exposure to the main solvent, form a gel that is permeable to the main solvent. Examples of gelling agents include but are not limited to: polysaccharides including cellulose; water absorbent polyacrylic polymers and copolymers such as Carbopol® sold by Noveon, Inc.; poloxamer block copolymer such as Poloxamer 407 sold by BASF under the trade name Pluronic®; polyvinyl alcohol sold under the trade name “Elvanol” by DuPont; poly(ethylene oxide) such as Polyox™ sold by Dow Chemical, can be used. Gelling agents can be a stand-alone polymer as illustrated or a combination of components that may include a stiffening agent or cross-linking agent that slow the dissolution rate of the tablet and/or increase viscosity.

Gelling agents comprise at least one gel-forming polymer. The gel-forming polymer can be natural, such as a gum (e.g. Xanthun gum), semisynthetic such as a polysaccharide (e.g. cellulose derivative), or synthetic such as a poloxamer (block co-polymer of polyoxyethylene and polyoxypropylene), carbomer (crosslinked polymer of acrylic acid), poly (ethylene oxide) and polyvinyl alcohol. The preferred gel-forming polymers are synthetic, as synthetic polymers exemplified by polyvinyl alcohol and ethylene modified copolymer sold under the trade name Exceval® and manufactured by Kuraray Specialties Europe demonstrate high levels of oxidation resistance. However, natural and semisynthetic polymers may be used especially as an additional gel-forming polymer, or in cases where the oxidizers are precoated with a barrier film, such as fumed silica, magnesium carbonate light, borates, and the like. The gel-forming polymer may be included in the solid composition in the form of a tablet in an amount ranging from 0.1 to 10 wt % based on the total weight of the composition.

### 6) Desiccant

Desiccant can be applied to remove residual moisture from the chlorite donor as well as other reactants. Examples of desiccants include but may not be limited to magnesium oxide, anhydrous sodium sulfate, anhydrous magnesium sulfate, unsaturated magnesium sulfate in which the magnesium sulfate is not fully hydrated and has less water of hydration than magnesium sulfate heptahydrate, calcium silicate, calcium oxide, and the like. A desiccant can also be the non-hygroscopic material such as magnesium oxide.

### A. Structure

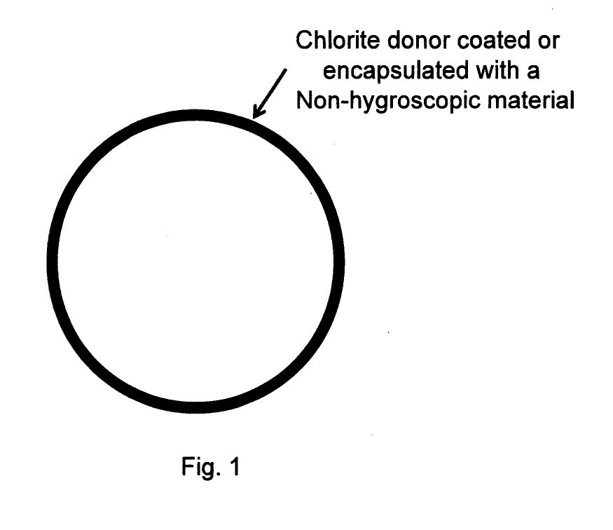

FIG. 1 is an exemplary embodiment of the chlorite donor coated with a non-hygroscopic material. While the exemplary embodiment is spherical and shows only one face of a chlorite donor with a homogenous coating encapsulating the chlorite donor core, the invention is not so limited. The coating may be uneven and scattered, appearing as specks on the surface upon close view. The chlorite donor may be in any variety of shapes and configurations.

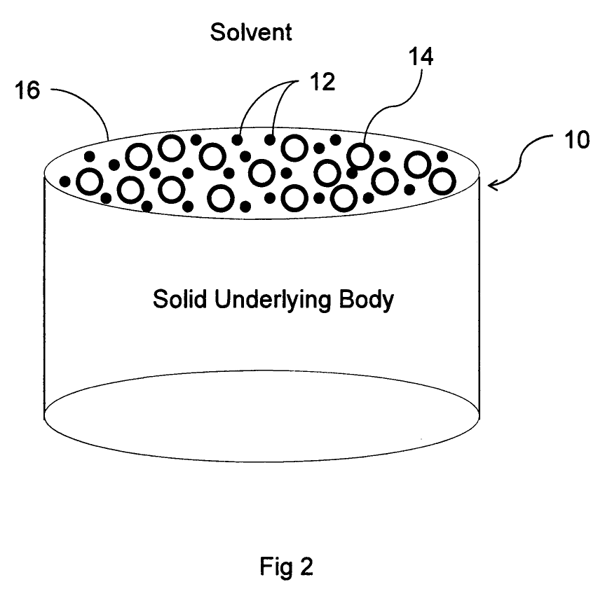

FIG. 2 is an exemplary embodiment of reactor 10 in accordance with an embodiment of the invention. Although the reactor 10 in this exemplary embodiment is cylindrically shaped, the invention is not so limited. The reactor 10 is an aggregate composition containing one or more reactants 12 and a chlorite donor coated or encapsulated with a non-hygroscopic material 14. Although the reactants 12 and the chlorite donor are shown only for a solvent interface 16 of the reactor 10, they are preferably present throughout the reactor 10. The non-hygroscopic material of 14 forms a moisture resistant barrier that helps reduce the potential of premature release of chlorine dioxide until it comes in contact with the main solvent.

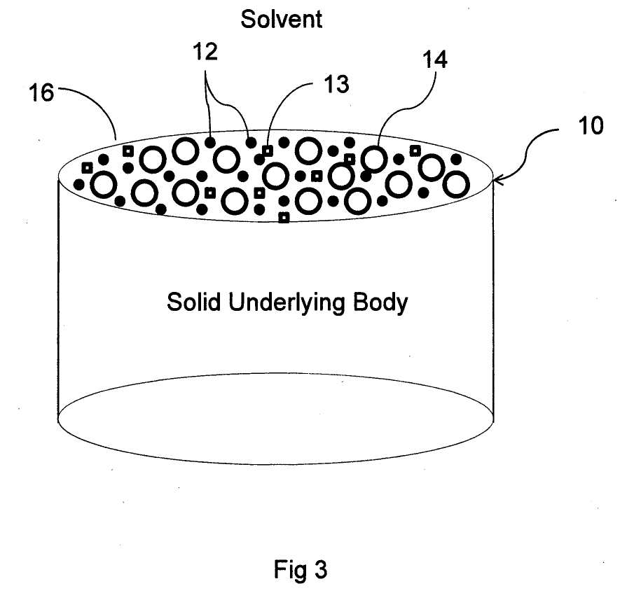

FIG. 3 is an exemplary embodiment of reactor 10 in accordance with an embodiment of the invention. Although the reactor 10 in this exemplary embodiment is cylindrically shaped, the invention is not so limited. The reactor 10 is an aggregate composition containing one or more reactants 12, binder 13, and a chlorite donor coated or encapsulated with a non-hygroscopic material 14. Although the reactants 12, binder 13, and the chlorite donor coated or encapsulated with a non-hygroscopic material 14 are shown only for a solvent interface 16 of the reactor 10, they are preferably present throughout the reactor 10. The non-hygroscopic material forms a moisture resistant barrier that helps reduce the potential of premature release of chlorine dioxide until it comes in contact with the main solvent. Although only one interface 16 is shown in this example for simplicity of illustration, there may be multiple interfaces between the reactor 10 and the main solvent; in fact, the reactor 10 may be placed in a bulk body of main solvent thereby resulting in complete immersion.

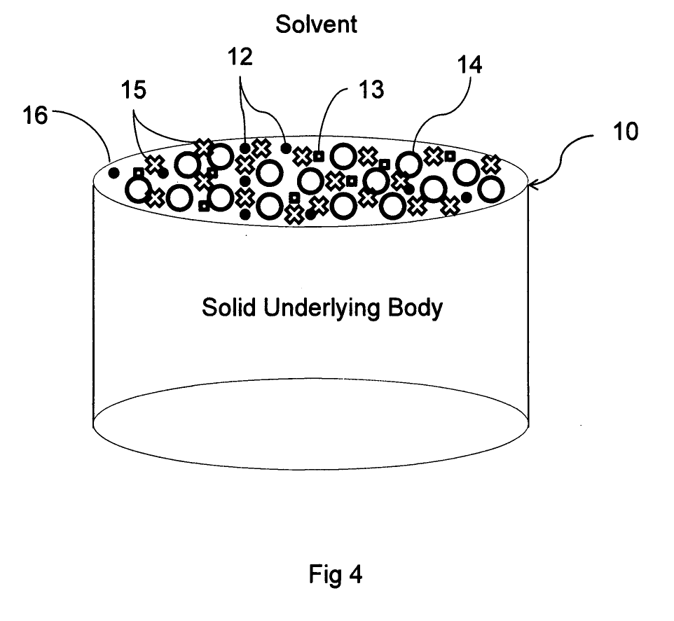

FIG. 4 is an exemplary embodiment of reactor 10 in accordance with an embodiment of the invention. Although the reactor 10 in this exemplary embodiment is cylindrically shaped, the invention is not so limited. The reactor 10 is an aggregate composition containing one or more reactants 12, binder 13, a chlorite donor coated or encapsulated with a non-hygroscopic material 14, and non-hygroscopic material 15 that acts as a barrier between reactants. Although the reactants 12, binder 13, and the chlorite donor coated or encapsulated with a non-hygroscopic material 14 are shown only for a solvent interface 16 of the reactor 10, they are preferably present throughout the reactor 10. The non-hygroscopic material forms a moisture resistant barrier that helps reduce the potential of premature release of chlorine dioxide until it comes in contact with the main solvent. Although only one interface 16 is shown in this example for simplicity of illustration, there may be multiple interfaces between the reactor 10 and the main solvent; in fact, the reactor 10 may be placed in a bulk body of main solvent thereby resulting in complete immersion.

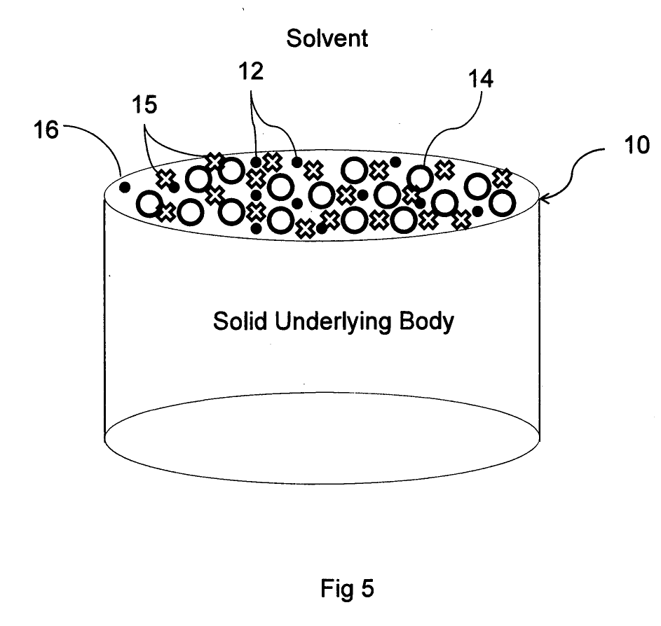

FIG. 5 is an exemplary embodiment of reactor 10 in accordance with an embodiment of the invention. Although the reactor 10 in this exemplary embodiment is cylindrically shaped, the invention is not so limited. The reactor 10 is an aggregate composition containing one or more reactants 12, a chlorite donor coated or encapsulated with a non-hygroscopic material 14, and non-hygroscopic material 15 that acts as a barrier between reactants. Although the reactants 12, and the chlorite donor coated or encapsulated with a non-hygroscopic material 14 are shown only for a solvent interface 16 of the reactor 10, they are preferably present throughout the reactor 10. The non-hygroscopic material forms a moisture resistant barrier that helps reduce the potential of premature release of chlorine dioxide until it comes in contact with the main solvent. Although only one interface 16 is shown in this example for simplicity of illustration, there may be multiple interfaces between the reactor 10 and the main solvent; in fact, the reactor 10 may be placed in a bulk body of main solvent thereby resulting in complete immersion.

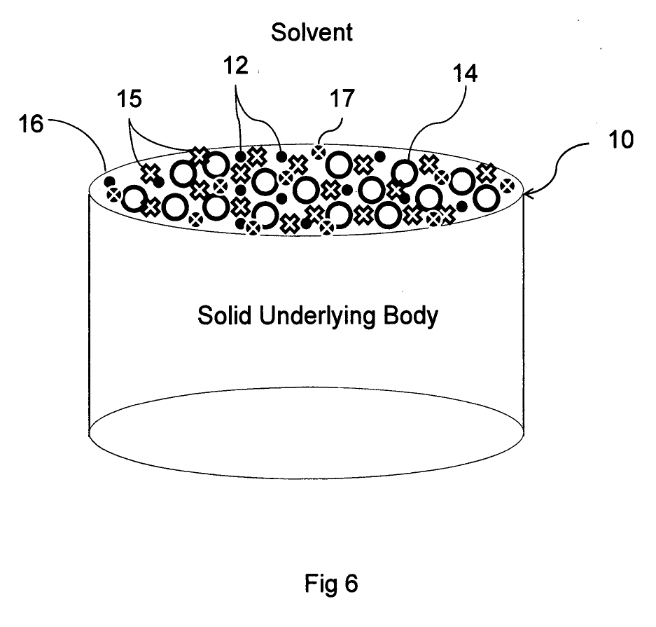

FIG. 6 is an exemplary embodiment of reactor 10 in accordance with an embodiment of the invention. Although the reactor 10 in this exemplary embodiment is cylindrically shaped, the invention is not so limited. The reactor 10 is an aggregate composition containing one or more reactants 12, a chlorite donor coated or encapsulated with a non-hygroscopic material 14, a non-hygroscopic material 15 that acts as a barrier between reactants, and a desiccant material 17. Although the reactants 12, and the chlorite donor coated or encapsulated with a non-hygroscopic material 14 are shown only for a solvent interface 16 of the reactor 10, they are preferably present throughout the reactor 10. The non-hygroscopic material forms a moisture resistant barrier that helps reduce the potential of premature release of chlorine dioxide until it comes in contact with the main solvent. Although only one interface 16 is shown in this example for simplicity of illustration, there may be multiple interfaces between the reactor 10 and the main solvent; in fact, the reactor 10 may be placed in a bulk body of main solvent thereby resulting in complete immersion.

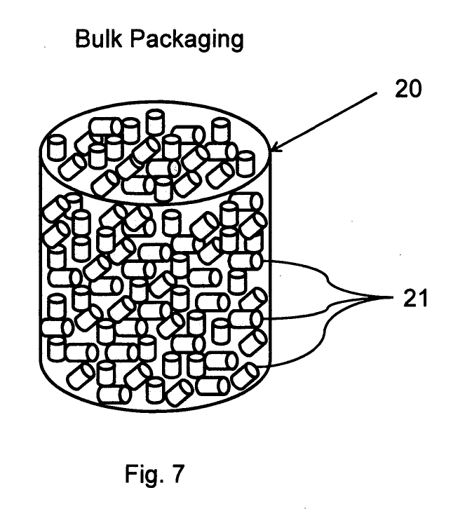

FIG. 7 is exemplary of bulk packaging but is not intended to limit the types of packaging, multiple layers of packaging that can be implemented to reduce damage to the solid tablet composition, or solid tablet configuration. Additional layers of packaging may include but not limited to: plastic liners; inclusion of desiccant packets such as silica based desiccant; and gas purging of the package such as nitrogen gas purging. Illustration 20 represents a container or packaging into which the solid tablets 21 are contained. A lid or enclosure, more preferably a sealable lid or enclosure is used to reduce the potential for exposure to the external environment.

### Water Soluble Tablet

In many applications a completely water soluble tablet is desired, whereby no suspended solids or residue that can settle out of the solution exist. For these applications, the preferred non-hygroscopic materials are those that meet the criteria of a non-hygroscopic material but dissolve, such as in the case of magnesium carbonate light or magnesium oxide or hydroxide exposed to dilute acid.

A water soluble solid composition in the form of a tablet with enhanced environmental stability that produces a solution chlorine dioxide on demand upon contact with water, the composition comprising: a solid chlorite donor in an amount to obtain at least 20 wt % chlorine dioxide when the composition is contacted with water; a low solubility free halogen donor ranging from 12-60 wt % and in sufficient amount to convert at least 70 wt % of the chlorite anion to chlorine dioxide; an acid source in sufficient amount to provide a pH of less than 7.8 when 1 gram of tablet composition is dissolved in 100 ml of water; at least one non-hygroscopic material comprising from 0.1 wt % to 10 wt % of the composition that coats at least the chlorite donor, and

wherein the non-hygroscopic material is completely dissolved in the solution of chlorine dioxide.

The non-hygroscopic materials of choice for water soluble compositions include but are not limited to: magnesium carbonate light, magnesium oxide.

### Substantially Water Soluble Tablet

In many applications a substantially water soluble tablet is desired, whereby some suspended solids or residue is acceptable. For these applications, the preferred non-hygroscopic materials are those that meet the criteria of a non-hygroscopic material but may not completely dissolve, such as in the case of fumed silica.

A substantially water soluble solid composition in the form of a tablet with enhanced environmental stability that produces a solution chlorine dioxide on demand upon contact with water, the composition comprising: a solid chlorite donor in an amount to obtain at least 20 wt % chlorine dioxide when the composition is contacted with water; a low solubility free halogen donor ranging from 12-60 wt % and in sufficient amount to convert at least 70 wt % of the chlorite anion to chlorine dioxide; an acid source in sufficient amount to provide a pH of less than 7.8 when 1 gram of tablet composition is dissolved in 100 ml of water, and

wherein, at least one non-hygroscopic material comprising from 0.1 wt % to 10 wt % of the composition that coats at least the chlorite donor.

The non-hygroscopic materials of choice for water soluble compositions include but are not limited to hydrophilic fumed silica, and hydrophobic fumed silica.

### Applying the Non-Hygroscopic Material

The non-hygroscopic material can be mixed with at least the chlorite donor, all of the reactants comprising the solid composition or combination of components including additives not reactants used for producing chlorine dioxide prior to forming a tablet. A ribbon mixer, tumbler or any convenient commercially viable means of applying the coating to the reactant(s) may be used.

The coating may be applied by physically attaching the non-hygroscopic material to the surface of the reactant by using methods such as Magnetically Assisted Impact Coating (MAIC).

In yet another application, the non-hygroscopic material is applied to the surface of at least the chlorite donor by spraying a solution or slurry of the non-hygroscopic material onto a surface of the chlorite donor in a fluid bed coating system followed by drying. A suitable method is exemplified by the Wurster process wherein the solid chlorite donor is suspended in a stream of heated air and a solution of non-hygroscopic material is sprayed onto the surface of the chlorite donor where it is then dried in the stream of air thereby coating or encapsulating the chlorite donor.

Making the Solid Composition into a Tablet

Tablet presses, roller compactors and the like may be used to produce the solid composition into the form of a tablet. Tablets can be configured to any geometric shape and size that is practical for the equipment being used and the application into which the tablet will be applied. Without intent to limit the suppliers or types of equipment suitable for producing tablets, one example of a manufacturer of tablet forming equipment is SMI Incorporated, Lebanon, N.J.

Coated Chlorite with Powdered Non-Hygroscopic Material

Two samples of commercial sodium chlorite with a minimum 82 wt % as NaClO2 was coated with approximately 4.92 wt % of CAB-O-SIL M-5 (Group A), and CAB-O-SIL TS-710 (Group B), then combined and mixed with trichloroisocyanuric acid and fumaric acid in the proportions listed in the data below. The tablets were pressed using a Carver press to form a tablet. Each tablet was weighed then added to 1000 ml of water.

After the tablet had completely dissipated, the sealed samples were allowed to rest for 24 hours to allow the fumed silica to settle, thereby providing a clear yellow solution of chlorine dioxide.

A sample from each was collected and tested using a HACH 2800 spectrophotometer.

### Enhanced Weight Percent Yield and Environmental Stability

The results of the test clearly illustrate the synergistic effects of combining: sodium chlorite coated with a non-hygroscopic material, a low solubility free halogen donor, and acid source comprising a carboxylic acid.

| | | | | | chlorine | | |
|---|---|---|---|---|---|---|---|
| | | | | max | dioxide | | con- |
| | tablet | sodium chlorite | | ClO2 | conc | wt | version |
| Sample | (g) | wt % | water(ml) | (ppm) | ppm | % | % |
| Group | | | | | | | |
| A | | | | | | | |
| | 1.64 | 0.58 | 1000 | 580 | 557 | 34 | 96 |
| | 1.631 | | | 577 | 573 | 35 | 99 |
| | 1.558 | | | 551 | 536 | 34.4 | 97 |
| | 1.801 | | | 637 | 633 | 35 | 99 |
| | 1.511 | | | 535 | 526 | 34.8 | 98 |
| Group | | | | | | | |
| B | | | | | | | |
| | 1.254 | 0.58 | 1000 | 444 | 369 | 29.4 | 83 |
| | 1.689 | | | 598 | 596 | 35.3 | 99.6 |
| | 1.442 | | | 510 | 495 | 34.3 | 97 |
| | 1.695 | | | 600 | 599 | 35.3 | 99.8 |
| | 1.568 | | | 555 | 552 | 35.2 | 99.4 |
| | Group A | Group B | | | | | |
| SC | 11.6 | 11.6 | SC = 82% dried for 5 hours 135 deg F. | | | | |
| TCCA | 4.4 | 4.4 | | | | | |
| FCWS | 3.4 | 3.4 | | | | | |

| | | | |
|---|---|---|---|
| TS-710 | 0.6 | | TS-710 = fumed hydrophobic |
| M-5 | | 0.6 | M-5 = fumed hydrophilic |

### Stability of Powdered Solid Compositions

Sodium Chlorite having a minimum sodium chlorite activity of 82 wt % was sent to Aveka, Inc. located in Woodbury Minn. Samples of Magnesium Carbonate light and fumed silica CAB-O-SIL HS-5 were provided as well. Samples of sodium chlorite were coated with 4 wt % of the magnesium carbonate light, and a second sample was coated with CAB-O-SIL HS-5 using Magnetic Assisted Impact Coater (MAIC). SEM imaging of the resulting coated sodium chlorite showed the coating method results in a uniform coating that encapsulates the sodium chlorite core.

A sample of each coated chlorite was combined with trichloroisocynauric acid, and fumaric acid in the reported proportions in a glass beaker, covered and thoroughly mixed. After mixing the cover was removed exposing the powder mixture to atmospheric conditions.

Coated sodium chlorite—11.6 grams
Trichloroisocynauric acid—4.4 grams
fumaric acid—3.4 grams

A comparative sample (blank) was prepared using uncoated sodium chlorite, mixed in a glass beaker and uncovered. The mixture comprised the following:

uncoated sodium chlorite—11.14 grams
trichloroisocyanuric acid—4.4 grams
fumaric acid—3.4 grams

The blank sample, within 10 minutes emitted the distinct odor of chlorine dioxide. After 30 minutes, there was an observable yellow gas on the surface of the powder. After 50 minutes the yellow gas was much stronger and the sample was discarded.

Both MAIC coated powdered mixtures remained stable. After 24 hours the samples remained white in color and did not emit any detectable odor.

The coating of at least the chlorite donor with a non-hygroscopic material dramatically improves the environmental stability of the composition. Combining the coated chlorite with other reagents such as a low solubility free halogen donor exemplified by trichloroisocyanuric acid and non-hygroscopic acid source exemplified by fumaric acid greatly enhance the environmental stability while providing for a composition in the form of a tablet that provides a weight percent yield of at least 20 wt %, more preferably 25 wt % and most preferred 30 wt %.

While the foregoing has been with reference to a particular embodiment of the invention, it will be appreciated by those skilled in the art that changes in this embodiment may be made without departing from the principles and spirit of the invention.

What is claimed is:

1. A fast-acting solid composition in the form of a tablet with enhanced environmental stability that produces a solution of chlorine dioxide on demand upon contact with water, the composition comprising: a solid chlorite donor in an amount to obtain at least 20 wt % chlorine dioxide when the composition is contacted with water; a low solubility free halogen donor ranging from 12-60 wt % and in sufficient amount to convert at least 70 wt % of the chlorite anion to chlorine dioxide; an acid source in sufficient amount to provide a pH of less than 7.8 when 1 gram of tablet composition is dissolved in 100 ml of water; a non-hygroscopic material ranging from 0.1 wt % to 10 wt % and coating at least the chlorite donor, the coating: providing a protective barrier on the surfaces of the chlorite donor; inhibits the adsorption of environmental moisture onto the surface of the chlorite donor; restricts the premature formation of chlorine dioxide, and
wherein all wt % being based on the total weight of the composition unless otherwise stated.

2. The composition according to claim 1, wherein the non-hygroscopic material completely dissolves in the solution of chlorine dioxide.

3. The composition according to claim 1, wherein the non-hygroscopic material is present in an amount of 1.0 wt % to 10 wt %.

4. The composition according to claim 1, wherein the chlorite donor comprises sodium chlorite.

5. The composition according to claim 1, wherein the chlorite donor and the coating are present in an amount to provide at least 25 wt % yield of chlorine dioxide when the composition is contacted with water.

6. The composition according to claim 1, wherein the chlorite donor and the coating are present in an amount to provide at least 30 wt % yield of chlorine dioxide when the composition is contacted with water.

7. The composition according to claim 1, wherein the free halogen donor comprises a low solubility free halogen donor having a solubility of no greater than 5 grams per 100 ml of water at 25° C.

8. The composition according to claim 1, wherein the free halogen donor comprises trichloroisocyanuric acid.

9. The composition according to claim 1, wherein the free halogen donor is coated with a non-hygroscopic material.

10. The composition according to claim 1, wherein the acid source comprises at least one acid selected from the group consisting of dicarboxylic acids and tricarboxylic acids.

11. The composition according to claim 1, wherein the acid source comprises fumaric acid.

12. The composition according to claim 1, wherein the at least the chlorite donor is coated with a non-hygroscopic material comprising magnesium carbonate.

13. The composition according to claim 1, wherein the at least the chlorite donor is coated with a non-hygroscopic/material comprising magnesium oxide.

14. The composition according to claim 1, wherein the at least the chlorite donor is coated with a non-hygroscopic material comprising fumed silica.

15. The composition according to claim 1, further comprising a gel-forming polymer.

16. The composition according to claim 1, further comprising an effective amount of combustion suppressing boron donor to meet 5.1 Division Solid Oxidizers, Packing Group II as defined under UN/DOT criteria.

17. The composition according to claim 1, further comprising a desiccant.

18. The composition according to claim 17, wherein the desiccant comprises magnesium oxide.

19. The composition according to claim 17, wherein the desiccant comprises unsaturated magnesium sulfate.

20. A fast-acting solid composition in the form of a tablet with enhanced environmental stability that produces a solution of chlorine dioxide on demand upon contact with water, the composition comprising: sodium chlorite in an amount to obtain at least 20 wt % chlorine dioxide when the composition is contacted with water; trichloroisocyanuric acid ranging from 12-60 wt % and in sufficient amount to convert at least 70 wt % of the chlorite anion to chlorine dioxide; fumaric acid in sufficient amount to provide a pH of less than 7.8 when 1 gram of tablet composition is dissolved in 100 ml of water, and
a non-hygroscopic material ranging from 0.1 wt % to 10 wt % and coating at least the chlorite donor, the coating: providing a protective barrier on the surfaces of the chlorite donor; inhibits the adsorption of environmental moisture onto the surface of the chlorite donor; restricts the premature formation of chlorine dioxide, and
wherein all wt % being based on the total weight of the composition unless otherwise stated.

21. The composition according to claim 20, further comprising an effective amount of combustion suppressing boron donor to meet 5.1 Division Solid Oxidizers, Packing Group II as defined under UN/DOT criteria.

22. The composition according to claim 20, wherein the at least the chlorite donor is coated with a non-hygroscopic material comprising magnesium carbonate.

23. The composition according to claim 20, wherein the at least the chlorite donor is coated with a non-hygroscopic material comprising magnesium oxide.

24. The composition according to claim 20, wherein the at least the chlorite donor is coated with a non-hygroscopic material comprising fumed silica.

25. The composition according to claim 20, further comprising a desiccant.

26. The composition according to claim 25, wherein the desiccant comprises magnesium oxide.

27. The composition according to claim 25, wherein the desiccant comprises unsaturated magnesium sulfate.

28. The composition according to claim 20, further comprising a gel-forming polymer.

29. A fast-acting solid composition in the form of a tablet that produces a solution of chlorine dioxide on demand upon contact with water, the composition comprising: sodium chlorite ranging from about 33-69 wt % as commercial sodium chlorite based on having an 82 wt % sodium chlorite activity and in an amount to obtain at least 20 wt % chlorine dioxide when the composition is contacted with water; trichloroisocyanuric acid ranging from 12-64 wt % and in sufficient amount to convert at least 70 wt % of the chlorite anion to chlorine dioxide; fumaric acid ranging from about 3-50 wt % and in sufficient amount to provide a pH of less than 7.8 when 1 gram of tablet composition is dissolved in 100 ml of water, the fumaric acid functioning as an acid source and non-hygroscopic material, provides a protective barrier on the surfaces of the chlorite donor, inhibits the adsorption of environmental moisture onto the surface of the chlorite donor, and restricts the premature formation of chlorine dioxide, and
wherein all wt % being based on the total weight of the composition unless otherwise stated.

30. The composition according to claim 29, further comprising an effective amount of combustion suppressing boron donor to meet 5.1 Division Solid Oxidizers, Packing Group II as defined under UN/DOT criteria.

31. The composition according to claim 29, further comprising a desiccant.

32. The composition according to claim 31, wherein the desiccant comprises magnesium oxide.

33. The composition according to claim 31, wherein the desiccant comprises unsaturated magnesium sulfate.

34. The composition according to claim 29, further comprising a gel-forming polymer.

35. A method of producing chlorine dioxide on demand comprising contacting a fast-acting solid composition in the form of a tablet with enhanced environmental stability with water, the solid composition comprising:
a solid chlorite donor in an amount to obtain at least 20 wt % chlorine dioxide when the composition is contacted with water; a low solubility free halogen donor ranging from 12-60 wt % and in sufficient amount to convert at least 70 wt % of the chlorite anion to chlorine dioxide; an acid source in sufficient amount to provide a pH of less than 7.8 when 1 gram of tablet composition is dissolved in 100 ml of water; a non-hygroscopic material ranging from 0.1 wt % to 10 wt % and coating at least the chlorite donor, the coating: providing a protective barrier on the surfaces of the chlorite donor; inhibits the adsorption of environmental moisture onto the surface of the chlorite donor; restricts the premature formation of chlorine dioxide, and
wherein all wt % being based on the total weight of the composition unless otherwise stated.

36. The method according to claim 35, wherein the non-hygroscopic material is present in an amount of 1.0 wt % to 10 wt %.

37. The method according to claim 35, further comprising a gel-forming polymer.

38. The method according to claim 35, wherein the chlorite donor comprises sodium chlorite.

39. The method according to claim 35, wherein the chlorite donor and the coating are present in an amount to provide at least 25 wt % yield of chlorine dioxide when the composition is contacted with water.

40. The method according to claim 35, wherein the chlorite donor and the coating are present in an amount to provide at least 30 wt % yield of chlorine dioxide when the composition is contacted with water.

41. The method according to claim 35, wherein the free halogen donor comprises trichloroisocyanuric acid.

42. The method according to claim 35, wherein the free halogen donor comprises a low solubility free halogen donor having a solubility of no greater than 5 grams per 100 ml of water at 25° C.

43. The method according to claim 35, wherein the acid source comprises at least one acid selected from the group consisting of dicarboxylic acids and tricarboxylic acids.

44. The method according to claim 35, wherein the acid source comprises fumaric acid.

45. The method according to claim 35, further comprising using the chlorine dioxide produced as an antimicrobial agent.

46. The method according to claim 35, further comprising using the chlorine dioxide produced for the treatment of food processing applications.

47. The method according to claim 35, further comprising using the chlorine dioxide produced for the treatment of recirculating systems.

48. The method according to claim 35, further comprising using the chlorine dioxide produced for the treatment of hard surfaces.

49. The method according to claim 35, further comprising using the chlorine dioxide produced for the treatment of emergency drinking water.

50. The method according to claim 35, further comprising using the chlorine dioxide produced for the treatment of surgical instruments and equipment.

51. The method according to claim 35, wherein the non-hygroscopic material comprises magnesium carbonate.

52. The method according to claim 35, wherein the non-hygroscopic material comprises magnesium oxide.

53. The method according to claim 35, wherein the non-hygroscopic material comprises fumaric acid.

54. The method according to claim 35, wherein the non-hygroscopic material comprises fumed silica.

55. The method according to claim 35, wherein the solid composition comprises an effective amount of combustion suppressing boron donor to meet 5.1 Division Solid Oxidizers, Packing Group II as defined under UN/DOT criteria.
